(19) United States
(12) Patent Application Publication
(10) Pub. No.: US 2002/0169684 A1
(43) Pub. Date: Nov. 14, 2002

(54) Safety payment and auto exchange-giving system for electronic trading

(76) Inventor: Yueh Wen Chao, Lu Chou (TW)

Correspondence Address: Keith Kline, PRO-TECHTOR INTERNATIONAL SERVICES, 20775 Norada Court, Saratoga, CA, 95070-3018, US

(21) Appl. No.: 09/858,069

(22) Filed: May 14, 2001

(51) Int. Cl. G06F 17/60

(52) U.S. Cl. 705/26

(57) ABSTRACT

A safety payment and auto exchange-giving system of client-server architecture for on-line interactive trading, includes a server and a plurality of client side terminals. Through each client side terminal, the user orders the desired service and/or commodity, and then pays the payment either by cash through an auto change-giving machine at each client side terminal. Alternatively, the user can pay the payment after enjoyment of the ordered service or receipt of the ordered commodity.

### BACKGROUND OF THE INVENTION

1. Field of the Invention:

The present invention relates to a safety on-line trading system and, more particularly, to a safety payment and auto exchange-giving system for on-line trading.

2. Description of the Prior Art:

Making business through the Internet is rapid, efficient, and cost saving. Viewing from a certain angle, directly performing electronic trading has a great chance in future development because of the advantages of low routine expense, less number of employees, and needless of shops.

There is an importance concept in electronic trading, i.e., having an immediate, clear, and safety service during the process of making a payment, receiving a credit loan, or claiming a debit. With respect to making payment on the net, there is not an absolutely effective safety measure available, thereby causing the consumers and traders to worry about the security of direct on-line trading. SSL and SET are the most commonly used transmission protocols on the net. SSL provides the basic point-to-point communication security service for a trade between two parties on the Internet, i.e., SSL assures the safety of data communication between the consumer and the shop, however it cannot control the safety of the whole trade. SET defines in detail the interactive flow among the consumer, the shop, the collecting bank, and the credit-issuing bank, however it does not protect the consumer against the possibility of repeated claiming of payment by a lawless trader. Further, because SET does not consider the transportation of commodity, the trade is established before the consumer receives the commodity. To the consumer, payment security of trade is not well protected.

### SUMMARY OF THE INVENTION

The invention has been accomplished under the circumstances in view. It is the main object of the present invention to provide a safety payment and auto change-giving system for electronic trading, which allows the amount of payment to be directly paid by cash at the client side, or to be paid later after enjoyment of the service or receipt of the commodity when the buyer make an order through the client side. To achieve this and other objects of the present invention, the safety payment and auto exchange-giving system of the present invention is based on client-server architecture for on-line interactive trading. The system includes a server and a plurality of client side terminals. Through each client side terminal, the user orders the desired service and/or commodity, and then pays the payment either by cash through an auto change-giving machine at each client side terminal. Alternatively, the user can pay the payment after enjoyment of the ordered service or receipt of the ordered commodity.

### BRIEF DESCRIPTION OF THE DRAWINGS

FIG. 1 illustrates the system architecture of the present invention.

FIG. 2 illustrates an alternate form of the system architecture of the present invention.

### DETAILED DESCRIPTION OF THE PREFERRED EMBODIMENT

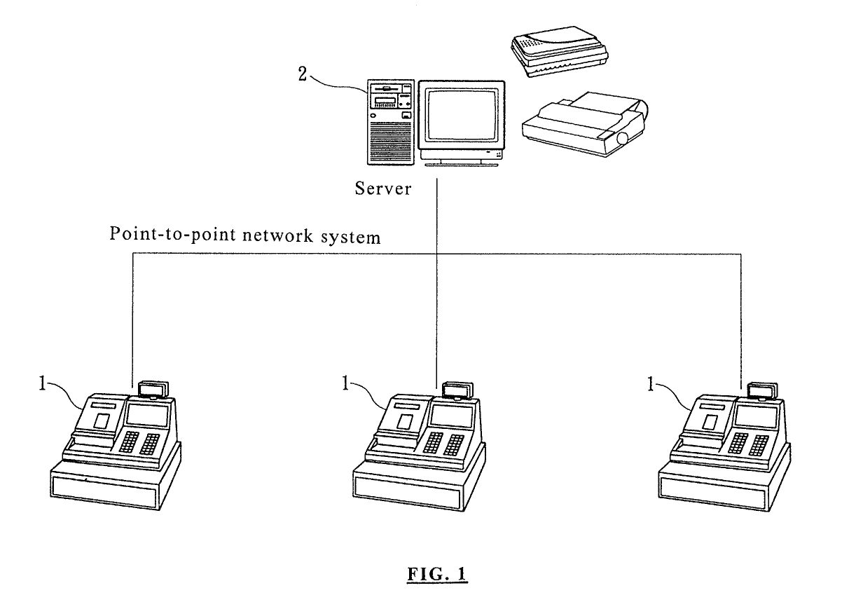

Referring to FIG. 1, the safety payment and auto exchange-giving system for on-line trading according to the present invention uses a communication network to provide an electronic shopping service, which enables the buyer to order service or commodity provided by the system provider. The safety payment and auto exchange-giving system for on-line trading is comprised of a plurality of client side terminals 1 respectively disposed at assigned locations, and a server 2 connected to the client side terminals 1. The client side terminal 1 provides an operation interface through which the user selects the desired service or commodity. The ordering message from the user is transmitted to the server, enabling the system provider to provide the related service or commodity subject to the ordering message received. Unlike conventional electronic trading methods, the invention allows the payment to be paid by cash, or paid after enjoyment of the service or receipt of the commodity. On another words, when ordered a commodity through one client side terminal 1, the consumer knows from the operation interface the amount to be paid. At this time, the consumer can select to pay at the site by cash, or to pay the amount later. When selected, the client side terminal 1 prints out the order sheet and the related document sheet for the consumer. In case the consumer selected payment by case and the cash payment has been done, the client side terminal 1 immediately prints an invoice or receipt for the consumer. On the contrary, if the consumer selected to pay the payment upon receipt of the ordered commodity, the consumer can pay the payment upon receipt of the ordered commodity, and the related invoice or receipt will be given to the consumer with the ordered commodity. In order to fit cash payment mode, the client side terminal 1 is provided with an auto change-giving machine, which accepts coins and paper currency, and give the exchange automatically.

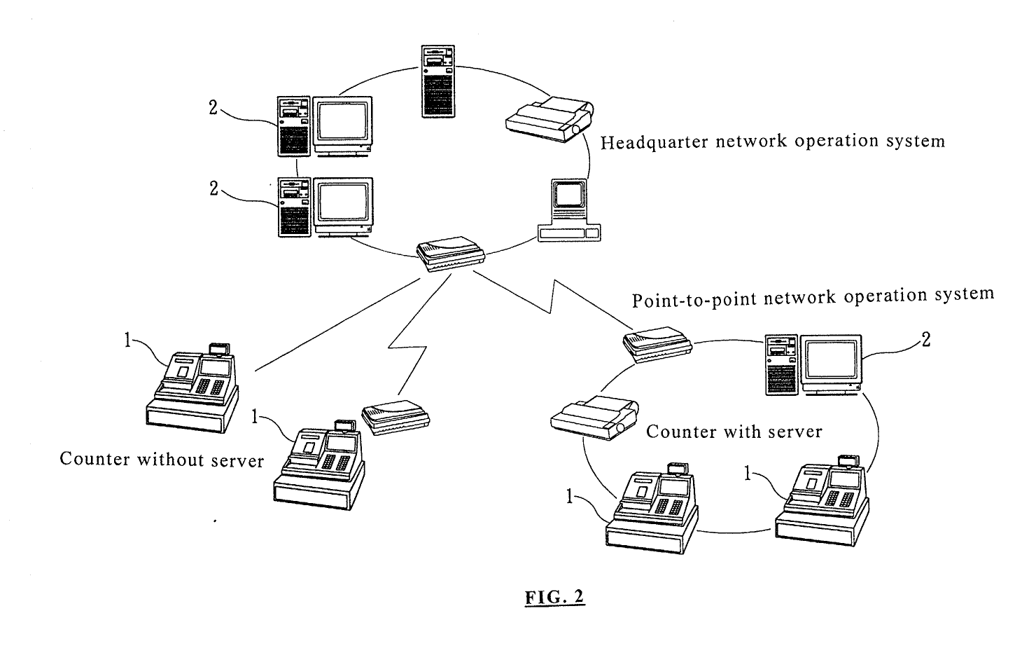

The system architecture shown in FIG. 1 is single counter architecture. In actual practice, the system can be of a multi-counter architecture (see FIG. 2), which includes server-provided counters and counters without server respectively connected to the network operation system of the headquarter.

A prototype of safety payment and auto exchange-giving system for on-line trading has been constructed with the features of FIGS. 1˜2. The safety payment and auto exchange-giving system for on-line trading functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A safety payment and auto exchange-giving system for on-line trading through a communication network, comprising:
a server built therein a service content and commodity data bank for application operation; and
a plurality of client side terminals respectively connected to said server, said client side terminals each comprising an operation interface adapted for enabling the user to select the desired service or commodity from said server, and an automatic change-giving machine adapted to receive coins and paper currency and to give the change.
